(19) United States
(12) Patent Application Publication
(10) Pub. No.: US 2008/0318507 A1
(43) Pub. Date: Dec. 25, 2008

(54) Closure Clip for a Packaging Tube

(76) Inventor: Martin Peach, Hamburg (DE)

Correspondence Address: MYERS BIGEL SIBLEY & SAJOVEC, PO BOX 37428, RALEIGH, NC, 27627, US

(21) Appl. No.: 12/066,182

(22) PCT Filed: Sep. 14, 2006
(86) PCT No.: PCT/EP06/08939

§ 371 Date: Jul. 17, 2008

(30) Foreign Application Priority Data
Sep. 14, 2005 (DE) 20 2005 014 590.4

(51) Int. Cl. A22C 11/12

(52) U.S. Cl. 452/48

(57) ABSTRACT

The subject matter of the invention is a closure clip for closing a packaging tube having two clip limbs (6, 7) and a clip base (5) which is arranged between the clip limbs (6, 7), the clip limbs (6, 7) being angled away with respect to the clip base (5), the surface of the closure clip (1) being provided entirely or partially with a structure which can be obtained by exposure to a particle jet (3).

The invention relates to a closure clip for closing a packaging tube. The closure clip comprises two clip limbs and a clip base which is arranged between the clip limbs, the clip limbs being angled away opposite in the clip base.

Closure clips of this type are used, in particular, in sausage production. Sausage meat is introduced into the packaging tube through a filling pipe. When a packaging unit is full, the end of the packaging tube is gathered to form a section without filling material, and the closure clip is bent around the section without filling material in order to close the packaging unit permanently.

For a secure closure, the friction between the closure clip and the packaging tube has to be so great that the closure clip cannot be pulled off the packaging tube by a force which acts parallel to the direction of the packaging tube. If the friction force proves to be too small, it has been customary up to now to compress the closure clip more firmly, with the result that it lies on the packaging tube with a greater pressure. In the case of packaging tubes made from natural casing, in particular, the pressure cannot, however, be increased as desired, since there is the risk of the casing tearing.

It is known from EP 0 337 301 B1 to provide the face which lies on the packaging tube with embossed depressions. The edges of the depressions engage to a certain extent into the material of the packaging tube, with the result that the friction between the closure clip and the packaging tube is increased in comparison with a smooth surface. Although the depressions which are embossed into the surface of the closure clips increase the friction, the effect is limited.

The invention is based on the object of proposing a closure clip which affords a further improved grip on the packaging tube. The object is achieved by the features of the independent claims. Advantageous embodiments are found in the subclaims.

According to the invention, the closure clip is distinguished by the fact that the surface of the closure clip is provided entirely or partially with a structure which can be obtained by exposure to a particle jet. The structure which can be obtained in this way has a multiplicity of fine elevations and depressions, with the result that the surface area is increased in comparison with a smooth form without a structure. The increased surface area lies on the packaging tube and the friction between the closure clip and the packaging tube is increased. A lower pressure between the closure clip and the packaging tube is required to ensure a secure grip.

A second effect which, in addition to the increased surface area, probably likewise contributes to improving the grip is the compression of the surface under the action of the particle jet. The particles which impact on the surface of the closure clip at high speed exert a great force on the surface of the closure clip in a locally narrowly delimited manner. The points, at which the surface material has a lower strength are compressed, with the result that small dents are formed. Since all of the surface is treated by the multiplicity of particles, the surface material is compressed overall. As a result, the structure of the surface has an increased strength overall, which likewise contributes to an improved grip between the closure clip and the packaging tube.

The structural features of the closure clip according to the invention cannot be readily summarized. It therefore appears expedient to define the features of the closure clip via the production process (product-by-process claim).

Tests have shown that the friction between the closure clip and the packaging tube is increased by way of the surface structure which is produced by a particle jet to a considerably greater extent than by way of the embossed depressions which are known in the prior art.

It is not necessary for the entire surface of the closure clip to be provided with a structure. A surface proportion of 20%, preferably 30%, more preferably 40% can be sufficient. It is decisive that the structure exists on that part of the surface, with which the closure clip lies on the packaging tube. Therefore, the side which is denoted as inner side of the closure clip and via which the clip limbs are angled away with respect to the clip base is preferably provided entirely or partially with the structure.

The particles of the particle jet are entrained by an air jet which moves at high speed. The air jet is preferably generated in such a way that it emerges from a pressure container at a pressure between 2 bar and 8 bar, more preferably at a pressure between 4 bar and 6 bar. In an air jet which is generated at this pressure, the particles have the suitable speed for producing the structure.

The particles can comprise any desired one of the substances which are conventionally used as jet material. It has proven advantageous if the particles are glass beads.

The exposure of the closure clip to a particle jet has proven particularly effective if the closure clip is produced from aluminum or an aluminum alloy.

As an alternative, the closure clip according to the invention can possibly be produced in such a way that it is not the surface of the closure clip itself which is exposed to a particle jet, but that rather a die is provided in this way with a corresponding surface structure. The die is used as a negative mold. A structure which corresponds to the surface structure of the die is produced on the closure clip as a result of compressive contact between the die and the closure clip.

In the following text, the invention will be described by way of example using one advantageous embodiment and with reference to the appended drawings, in which:

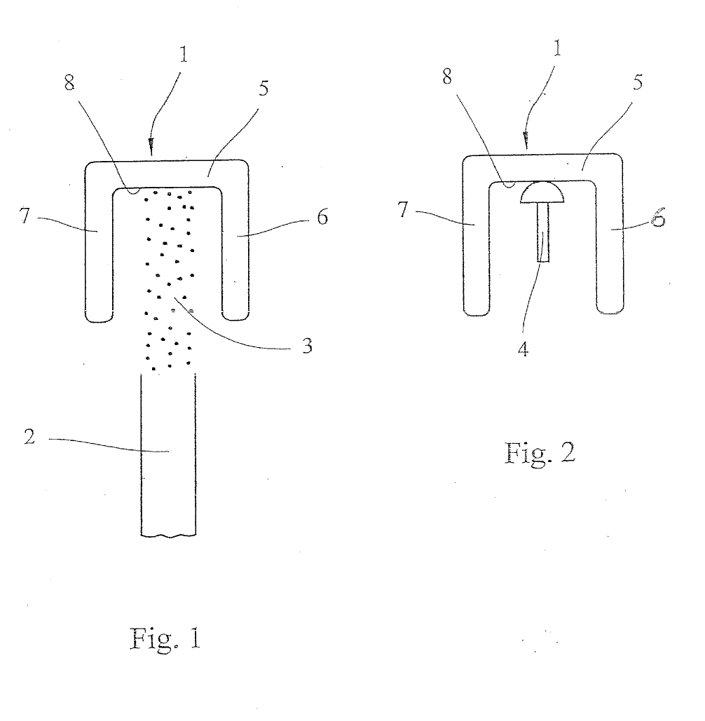

FIG. 1 shows a closure clip according to the invention; and

FIG. 2 shows a further closure clip according to the invention.

A closure clip 1 comprises a clip base 5 and two clip limbs 6, 7 which are bent over with respect to the clip base 5 via the inner side 8. In FIG. 1, the closure clip 1 is exposed on its inner side 8 to particles 3 which emerge from a jet pipe 2. The particles 3 act on the surface of the closure clip 1 and produce a structure on the surface, which structure comprises fine depressions and elevations.

When the closure clip 1 lies on a packaging tube by way of the structured surface, the friction is great between the surface of the closure clip and the packaging tube. More force is required to pull the closure clip 1 off from the packaging tube. The closure clip 1 provides a secure closure.

The exposure to the particle jet 3 can be the last step in the production of the closure clip 1, when the closure clip 1 which is otherwise finished is treated with the particle jet 3. As an alternative, the wire, from which the closure clip 1 is subsequently produced, can also be treated with the particle jet 3. In this case, the surface structure is produced in a substantially earlier stage of the production.

As an alternative, the structure can also be produced on the surface of the closure clip 1 with the aid of a die 4 according to FIG. 2. Prior to this, the surface of the die 4 has been exposed to a particle jet, with the result that the surface of the die 4 can serve as a negative mold for the structure on the surface of the closure clip 1. If a pressure is exerted on the surface of the closure clip 1 by way of the die 4, the closure clip 1 assumes the surface structure from the die 4.

1. A closure clip for closing a packaging tube having two clip limbs (6, 7) and a clip base (5) which is arranged between the clip limbs (6, 7), the clip limbs (6, 7) being angled away with respect to the clip base (5), characterized in that the surface of the closure clip (1) is provided entirely or partially with a structure which can be obtained by exposure to a particle jet (3).

2. The closure clip as claimed in claim 1, characterized in that the surface of the closure clip (1) is provided with the structure with a proportion of at least 20%, preferably at least 30% and more preferably 40%.

3. The closure clip as claimed in claim 1 or 2, characterized in that the inner side (8), via which the clip limbs (6, 7) are bent over with respect to the clip base (5), is provided entirely or partially with a structure.

4. The closure clip as claimed in one of claims 1 to 3, characterized in that the particle jet (3) is directed onto the surface at a pressure between 2 bar and 8 bar, preferably at a pressure between 4 bar and 6 bar.

5. The closure clip as claimed in one of claims 1 to 4, characterized in that the particles (3) are glass beads.

6. The closure clip as claimed in one of claims 1 to 5, characterized in that it is produced from aluminum or an aluminum alloy.

7. A closure clip for closing a packaging tube having two clip limbs (6, 7) and a clip base (5) which is arranged between the clip limbs (6, 7), the clip limbs (6, 7) being angled away with respect to the clip base (5), characterized in that the surface of the closure clip (1) is provided with a structure, and in that the structure can be obtained by pressure contact with a die (4), the die having a surface structure which is produced by exposure to a particle jet.
